(19) United States
(12) Patent Application Publication
(10) Pub. No.: US 2005/0008253 A1
(43) Pub. Date: Jan. 13, 2005

(54) Method and apparatus for eliminating irrelevant luminescent signals

(76) Inventor: Joseph Rozgonyi, Pepper Pike, OH (US)

Correspondence Address: Obermayer, Rebmann, Maxwell & Hippel, LLP;One Penn Center, 19th Floor, 1617 John F. Kennedy Blvd., Philadelphia, PA, 19103, US

(21) Appl. No.: 10/617,271

(22) Filed: Jul. 10, 2003

(51) Int. Cl. G06K 9/40

(52) U.S. Cl. 382/274

(57) ABSTRACT

A method for increasing the contrast between reflected and background luminescent on an object to be scanned comprising the following steps: targeting a signal on an object to be scanned for luminescence; varying the wavelength and/or intensity of the signal to produce a contrast between the luminescence on the object and any background luminescence; and processing the return signal to remove the background luminescence.

### FIELD OF THE INVENTION

This invention relates to the area of luminescent materials detection. In particular, the present invention relates to the problem of eliminating background luminescence in biotechnology, industrial automation and other applications.

### BACKGROUND OF THE INVENTION

When UV (ultraviolet) light is projected onto luminescent materials, it causes a visible light to be emitted back towards the UV light source or a light sensor and processing circuitry. In industrial automation and biotech applications, luminescent pigments are often used as a marker to be detected by luminescent scanners and sensors. Frequently, problems arise when the background materials associated with the luminescent material such as paper, wood etc., on which these markers are applied, also contain luminescent materials themselves, either naturally or as a result of prior processing. In such a case, the output of the luminescent reading may be inaccurate or difficult to distinguish from the background. There is a need for a system which can filter out or remove such non-relevant background luminescence.

There are a number of relevant prior art patents which relate to UV emitters and/or luminescent detectors. None are directed to a system which differentiates between emitted luminescence and the luminescence of a background material.

U.S. Pat. No. 6,144,035, for example, discloses a UV sensing apparatus comprises a substantially light-proof housing (1) an aperture (1a) formed in the housing, a filter (2) positioned within the housing at the internal mouth of the aperture, a fluorescent member (3) positioned within the housing on that side of the filter remote form that adjacent to the aperture, and alight sensor (4) positioned within the housing to receive light emitted by the fluorescent member. The filter (2) is such that it substantially removes visible light, the fluorescent member (3) is such as to fluoresce when subjected to UV radiation, and the light sensor (4) is positioned so that substantially none of the electromagnetic radiation entering the housing (1) via the aperture (2a) impinges upon the light sensor.

U.S. Pat. No. 5,347,342 a transilluminator comprising a housing having therein a UV-transmissible window and a UV light source supported within the housing for, transmitting UV light through the window. A surface within the housing reflects an image of the light source through the window so that the light source appears at the window to be more than one light source.

U.S. Pat. No. 6,211,524 describes a radiation detecting device comprising a, radiation sensing element, and a layer of luminescent material to expand the range of wavelengths over which the sensing element can efficiently detect radiation. The luminescent material being selected to absorb radiation at selected wavelengths, causing the luminescent material to luminesce, and the luminescent radiation to be detected by the sensing element. Radiation sensing elements include photodiodes (singly and in arrays), CCD arrays, IR detectors and photo multiplier tubes. Luminescent materials include polymers, oligomers, copolymers and porphyrines, Luminescent layers include thin films, thicker layers, and liquid polymers.

U.S. Pat. No. 5,557,415 describes an apparatus and a method for inducing an detecting fluorescence in a fluid medium containing at least one fluorophore. The apparatus comprises a light emitter adapted to emit light of a wavelength capable of exciting fluorophores in the fluid medium, a light detector adapted to detect fluorescence emitted by the fluorophores excited by the exciting light, a sensor body, preferably being solid and made of quartz, having internally reflecting wall parts capable of reflecting at least light having a wavelength corresponding to the wavelength of the fluorescence and having a sensor face adapted to receive exciting light from the light emitter, such as via an optical fiber, and to transmit the received exciting light into the fluid medium through the sensor face, to receive, through the sensor face, fluorescence emitted by excited fluorophores in the fluid medium, and to transmit at least part of the received fluorescence to the light detector, both the light emitter and the detector being positioned at a distance from the sensor face, and the relative positioning of the light emitter, the optical detector, and the sensor face being such that the detector is able to receive light transmitted from at least a portion of that part of the sensor face which receives light from the light emitter. The apparatus is especially well suited for operation in turbid or highly turbid media such as a fermentation tank or wastewater in a wastewater purification plant.

U.S. Pat. No. 6,444,476 to Morgan discloses a method for the conduct of a measurement of proximity between luminescent species based on detection of transfer of excitation energy between them. A first photoluminescent species (the “donor”) and a second photoluminescent species (the “acceptor”) are provided and are such that the donor species and the acceptor species have at least some excitation spectral regions which differ and that at least a part of the emission spectrum of the donor overlaps with at least a part of the excitation spectrum of the acceptor. The donor species is excited with a cyclical temporal sequence of wavelength bands, optionally provided as pulses or modulated in intensity, giving rise to a characteristic temporal fluctuation in emission therefrom and emission in at least one wavelength band characteristic of the acceptor is analyzed to detect the presence of the said characteristic fluctuation or a subcomponent thereof and optionally also to detect a fluctuation characteristic of direct excitation of the acceptor.

There is a long felt need for a system and method which will be able to measure the intensity and other factors of a luminescent object while filtering out luminescent emissions from background materials.

It is therefore an object of the present invention to provide a system which can accurately measure the luminescence of a luminescent object while filtering out unwanted background or irrelevant luminescent signals.

It is therefore an object of the present invention to provide a system which can accurately measure the luminescence of a luminescent object while filtering out the unwanted luminescence put forth by background objects such as paper, wood or other materials.

It is a further object of the present invention to accomplish this result by means of changing the frequency or intensity of the UV emitter which produces the luminescent signal so as to assist in eliminating irrelevant luminescent signals.

It is further object to achieve this by means of a beam splitter at an optical unit. These and other objects of the invention will become apparent from the attached summary and detailed descriptions which follow.

### SUMMARY OF THE INVENTION

The present invention relates to the area of luminescent materials detection. When UV light is projected onto luminescent makers, the luminescent material emits a visible light. In industrial automation and biotech applications, luminescent pigments are used as markers to be detected by luminescence light scanners and sensors.

Problems arise when background materials such as paper or wood also contain luminescent material naturally occurring or as a result of prior processing.

The present invention seeks to vary the intensity and/or the wavelength of the UV light projected on the target or marker to achieve higher contrast or difference in the luminescence as to enable the scanner or the sensor to differentiate between the marker and the background luminescence.

In accordance with the invention, a method for increasing the contrast between the luminescence generated by the target, or marker and background luminescence created by an object other than the target or marker comprising the following steps: targeting a signal on an object to be scanned for luminescence generation; varying the wavelength of the signal to produce a contrast between the luminescence on the object and any background luminescence; and processing the return signal to remove any remaining background luminescence.

In yet a further embodiment, the present invention is a method for creating the contrast between reflected and background luminescent on an object to be scanned comprising the following steps: targeting a luminescent signal on an object to be scanned for luminescence through an optical unit; varying the intensity of light through the optical unit to produce a contrast between the luminescence on the object and any background luminescence; and processing the return signal to remove any remaining background luminescence.

In still a further embodiment, the present invention is a system for processing the contrast between the luminescent material of an object to be scanned and luminescent material on the background comprising a source of UV light to be targeted on the object means for modulating the UV signal so as to change the characteristics of the signal so as to filter out background signal; means for detecting the luminescent signal from the modulated UV so as filter out background luminescence.

In yet a further embodiment, the invention comprises a system for processing the contrast between the luminescent material of an object to be scanned and luminescent material on the background comprising a source of UV light to be targeted on the object containing a luminescent material means for changing the intensity of the UV signal so as to change the characteristics of the signal so as to filter out unwanted background luminescent signal; means for detecting the luminescent signal from the modulated UV so as filter out background luminescence; and means for displaying the resultant filtered end signal.

### DESCRIPTION OF THE FIGURES

FIG. 1 is a block diagram of a first embodiment of the present invention.

FIG. 2 is a block diagram of a second embodiment of the present invention.

FIG. 3 is a block diagram of a third embodiment of the present invention.

FIG. 4 is a block diagram of a fourth embodiment of the present invention.

### DETAILED DESCRIPTION OF THE PREFERRED EMBODIMENT

The present invention is described with reference to the enclosed Figures wherein the same markers are used where applicable. The present invention, in a first embodiment, will vary the intensity amount and/or the wavelength of a UV light projected on a target. This is accomplished in order to achieve a higher contrast or difference in the luminescence set and so enable the scanner or the sensor to better differentiate between the marker and the background.

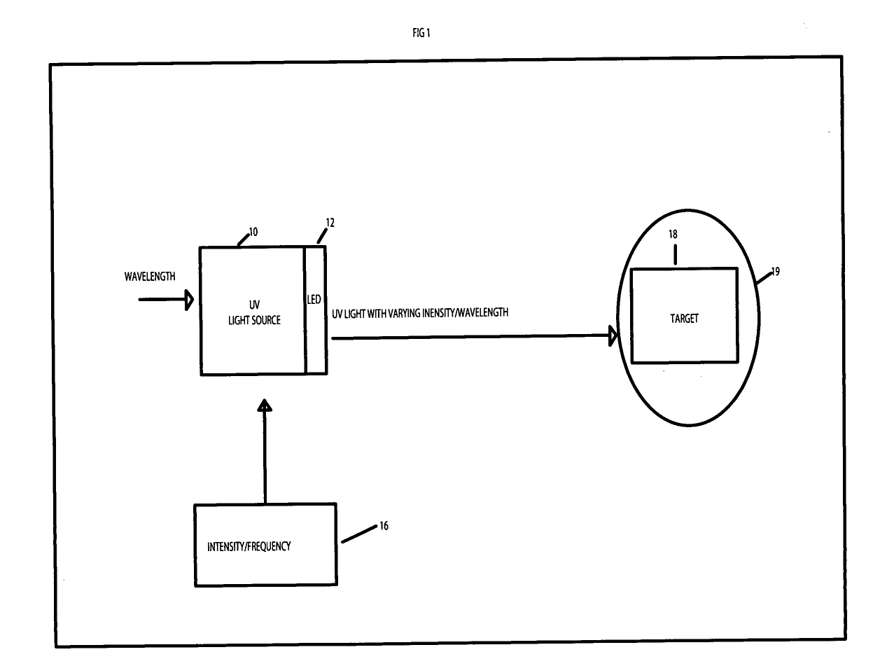

As shown in FIG. 1, the source 10, which may be LED 12, lamp or similar device generates a UV light or signal that can vary either in its intensity and/or wavelength. Those variables may be controlled by a micro controller 16, by manual means or other device. The emitted UV light triggers a luminescent reaction in the target which emits a visible light. A background emitted luminescent signal is also emitted 19. This may be triggered by a background pigment on wood or paper. A light detector 23 picks up the signal and it is processed 25 and displayed on an input/output device 21. Because of the intensity or frequency of the light emitted at LED 12, the background luminescence is easily filtered. The signal is then received and displayed on an output device 21.

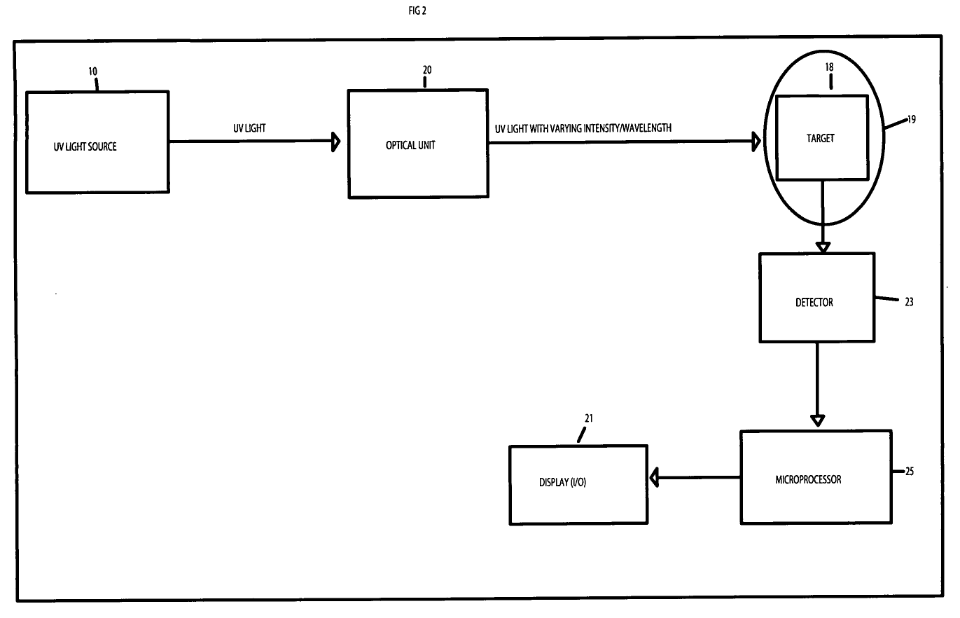

Referring to FIG. 2, an optical unit 20 can achieve the same effects of varying the intensity and wavelength of the signal. Optical unit 20 may consist of optical filters or light splitters etc., the that permits only a portion of the UV light through. By altering the filter, light splitters etc., the intensity of the light will be altered. The optical filter 20 may also control the wavelength that gets through the filter thereby allowing one range of wavelength to pass while blocking another.

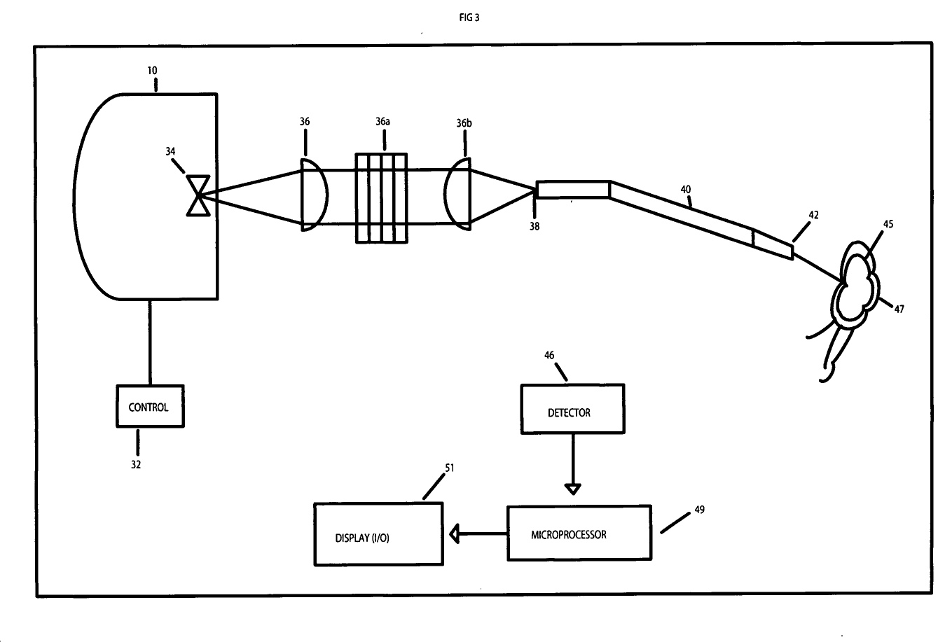

As shown in FIG. 3, a further embodiment of the invention is shown. Here, a UV signal light from an exciting light source 10, such as UV light from a lamp controlled by electronic controlling means 32 is emitted. A band pass filter 34 removes substantially all light not having a wavelength able to excite the fluorescent material of the target.

After filtration, the light passes through a lens bundle 36, 36a, 36b and is thereby focused on to a light receiving end 38 of a fibre optical means 40, preferably a fiber bundle. The exciting light is then guided by the fibre optical means 40 to a light emitting end 42 of the fibre optical means 40 and from there to a solid sensor body of a material 45 which is capable of transmitting the exciting light and fluorescence or luminescence is generated as a result of excitation with the exciting light. A background luminescence 47 is generated. Both materials contain fluorophores excitable by the exciting light, and luminescence will be generated.

A light detector 46 is positioned so as to directly detect luminescence. The detector 46 transforms the light signal received into an electrical signal representative of the amount of light received. The electrical signal is conducted to recording and/or calculating and/or process-regulating electronics such as a microprocessor 49, which eliminates any irrelevant luminescence caused by other objects other than material 45. The output is shown on a display 51 or other output device.

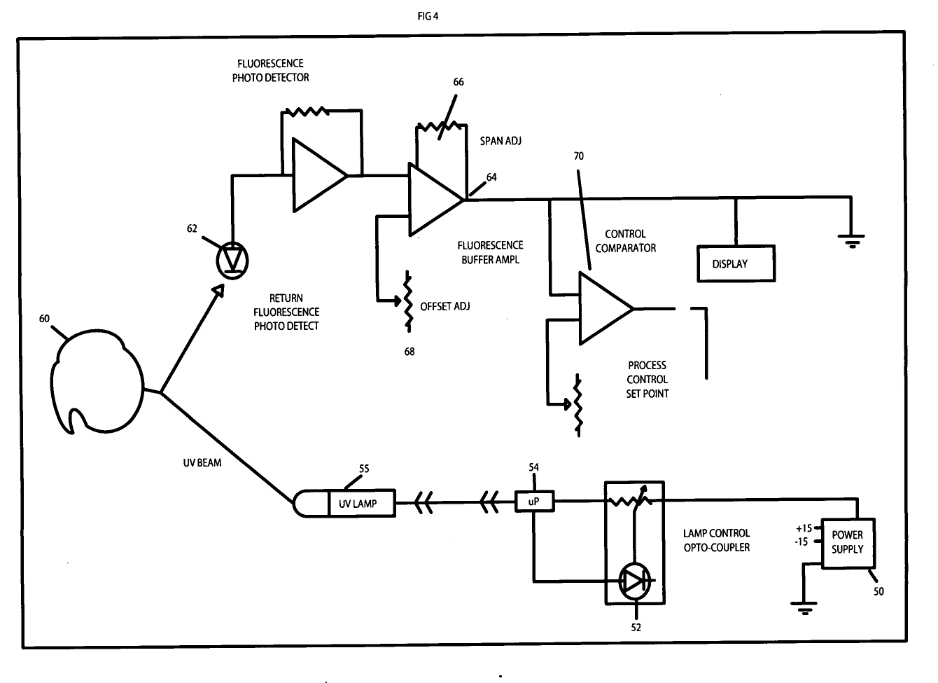

Referring to FIG. 4, there is shown a block diagram of yet another embodiment of a fluorescence measurement system of the present invention. Power is provided to a low voltage supply 50 and to the UV lamp control opto coupler 52. The UV lamp 55 intensity is varied by a microprocessor 54 which compares the lamp intensity with a reference signal developed which is adjusted to filter out background luminescence caused by an irrelevant object such as background paper.

A biological fluorescent or luminescent material 60 is situated near the UV light and generates a luminescence which is picked up by a fluorescence photo detector 62. This signal is conveyed to the fluorescence buffer amplifier 64, via the fluorescence photo detector amplifier and cable. The fluorescence buffer amplifier 64 trims the fluorescence signal for span and offset via a span adjustment potentiometer 66 and the offset adjustment potentiometer 68. The signal is transmitted to a control comparator 70 and displayed on a display device 72.

The present invention has been described with reference to the enclosed figures. It is to be appreciated that the true nature and scope of the present invention should be determined with reference to the attached claims.

1. A method for increasing the contrast between reflected and background luminescence on an object to be scanned comprising the following steps:
targeting a signal on an object to be scanned for luminescence;
altering a variable of the signal to produce a contrast between the luminescence on the object and any background luminescence caused by a second object not to be detected; and
processing the return signal to remove any background luminescence.

2. The method of claim 1 wherein the altered variable is signal intensity.

3. The method of claim 1 wherein the altered variable is UV light wavelength.

4. A method for processing the contrast between reflected and background luminescent on an object to be scanned comprising the following steps:
targeting a luminescent signal on an object to be scanned for luminescence through an optical unit;
varying the intensity of light through the optical unit to produce a contrast between the luminescence on the object and any background luminescence; and
processing the return signal to remove any background luminescence.

5. The method of claim 4 wherein the intensity of light permitted through to the object is varied by a beam splitter.

6. The method of claim 4 wherein the intensity of light, permitted to the object is varied by an optical filter.

7. A system for processing the contrast between the luminescent material of an object to be scanned and luminescent material on the background comprising:
a source of UV light to be targeted on the object;
means for modulating the the UV signal so as to change the characteristics of the signal so as to filter out background signal;
means for detecting the luminescent signal from the modulated UV so as filter out background luminescence.

8. A system for processing the contrast between the luminescent material of an object to be scanned and luminescent material on the background comprising:
a source of UV light to be targeted on the object containing a luminescent target material means for modulating the UV signal so as to change the characteristics of the signal so as to filter out unwanted background luminescent signal;
means for detecting the luminescent signal from the modulated UV so as to filter out background luminescence;
and means for displaying the resultant filtered end signal.
